(19) United States
(12) Patent Application Publication
(10) Pub. No.: US 2007/0173110 A1
(43) Pub. Date: Jul. 26, 2007

(54) Methods of connecting air cleaner cabinets to HVAC systems

(76) Inventors: Dwight H. Heberer, Brownsburg, IN (US); Danny L. Jenkins, Camby, IN (US); Stafford Wayne Stines, Indianapolis, IN (US); Chad E. Richardson, Avon, IN (US)

Correspondence Address: Charles N.J. Ruggiero;Ohlandt, Greeley, Ruggiero & Perle, L.L.P., 10th Floor, One Landmark Square, Stamford, CT, 06901-2682, US

(21) Appl. No.: 11/641,480

(22) Filed: Dec. 19, 2006

Related U.S. Application Data
(60) Provisional application No. 60/761,734, filed on Jan. 23, 2006.

(51) Int. Cl. H01R 33/945

(52) U.S. Cl. 439/517

(57) ABSTRACT

A method of connecting an air cleaner cabinet to a heat exchanger. The method includes inserting a first ear portion on the air cleaner into a receiving portion in a first adapter flange bracket so that the first ear portion is removably engaged in the receiving portion of the first adapter flange bracket, positioning a first side of the first adapter flange bracket in engagement with a second side of the heat exchanger, and inserting a first set of fasteners through a first set of plurality of holes in the first side of the first adapter flange bracket so that the first side of the first adapter flange bracket is removably connected to the second side.

### CROSS REFERENCE TO RELATED APPLICATIONS

This application claims the benefit of U.S. Provisional Application Ser. No. 60/761,734, filed Jan. 23, 2006, the contents of which are incorporated by reference in its entirety herein.

### BACKGROUND OF THE INVENTION

1. Field of the Invention

The present disclosure is related to methods of connecting air cleaner cabinets to HVAC systems. More particularly, the present disclosure is related to methods of connecting air cleaner cabinets to HVAC systems using adapter flange brackets.

2. Description of Related Art

Heating, ventilation, and air conditioning (hereinafter “HVAC”) systems circulate air through a building while conditioning the air to a desired temperature and/or humidity. It is often desired to filter the air as it passes through the HVAC system to remove particles and other contaminants from the air.

Currently, manufacturers of high efficiency electronic and mechanical air cleaner cabinets produce cabinets with varying dimensions for use with such HVAC systems. In use, the cabinets are attached to the HVAC system. Unfortunately due to the wide number of manufacturers and lack of standard sizes in the industry, the cabinet's dimensions often do not match the dimensions of the HVAC system to which it must be attached. In situations such as these, a number of problems can arise.

For example, dealers who install air cleaner cabinets directly to the bottom return of the HVAC system must come up with a way to attach the cabinet to the furnace. This often results in connections in which there are gaps between the cabinet and the furnace. These gaps must then be sealed in order to form airtight connections. Once again, the installer must devise a way to seal the gaps.

Thus, dealers who sell and install air cleaner cabinets have an interest in finding an easy, relatively inexpensive, and quick way to attach air cleaner cabinets to HVAC systems.

### BRIEF SUMMARY OF THE INVENTION

It is an object of the present disclosure to provide methods of connecting an air cleaner cabinet to a heat exchanger.

It is another object of the present disclosure to provide an HVAC system having a heat exchanger, an air cleaner cabinet, a plurality of adapter flange brackets, and a set of fasteners.

These and other objects and advantages of the present disclosure are provided by a method of connecting an air cleaner cabinet to a heat exchanger. The method includes inserting a first ear portion on the air cleaner into a receiving portion in a first adapter flange bracket so that the first ear portion is removably engaged in the receiving portion of the first adapter flange bracket, positioning a first side of the first adapter flange bracket in engagement with a second side of the heat exchanger, and inserting a first set of fasteners through a first set of plurality of holes in the first side of the first adapter flange bracket so that the first side of the first adapter flange bracket is removably connected to the second side.

An HVAC system is also provided. The system includes a heat exchanger having a plurality of sides. The system also includes an air cleaner cabinet having a plurality of sides and a plurality of ear portions. Additionally, a plurality of adapter flange brackets is provided. Each of the plurality of adapter flange brackets has a first side and a receiving portion. The first side has a plurality of holes. One of the plurality of ear portions engages with the receiving portion of a respective one of the plurality of adapter flange brackets. Additionally, a set of fasteners is present. Each one of the set of fasteners is inserted through each one of the plurality of holes and connects each of the first sides to one of the plurality of sides of the heat exchanger.

An air cleaning kit is also provided. The kit has a pair of adapter flange brackets. Each one of the pair of adapter flange brackets has a receiving portion. An air cleaner cabinet having a pair of ear portions is also present. The ear portion can be removably engaged in the receiving portion of a respective one of the pair of adapter flange brackets.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIG. 1 is a top perspective view of an exemplary embodiment of an adapter flange bracket according to the present disclosure in use with an HVAC system.

FIG. 2 is a top perspective view of the adapter flange bracket of FIG. 1.

FIG. 3 is a partially exploded view illustrating the assembly of the adapter flange bracket of FIG. 1 on a portion of the HVAC system.

FIG. 4 is a sectional view illustrating the interaction between the adapter flange bracket of FIG. 1 and the HVAC system.

FIG. 5 is an exemplary embodiment of an air cleaning kit.

### DETAILED DESCRIPTION OF THE INVENTION

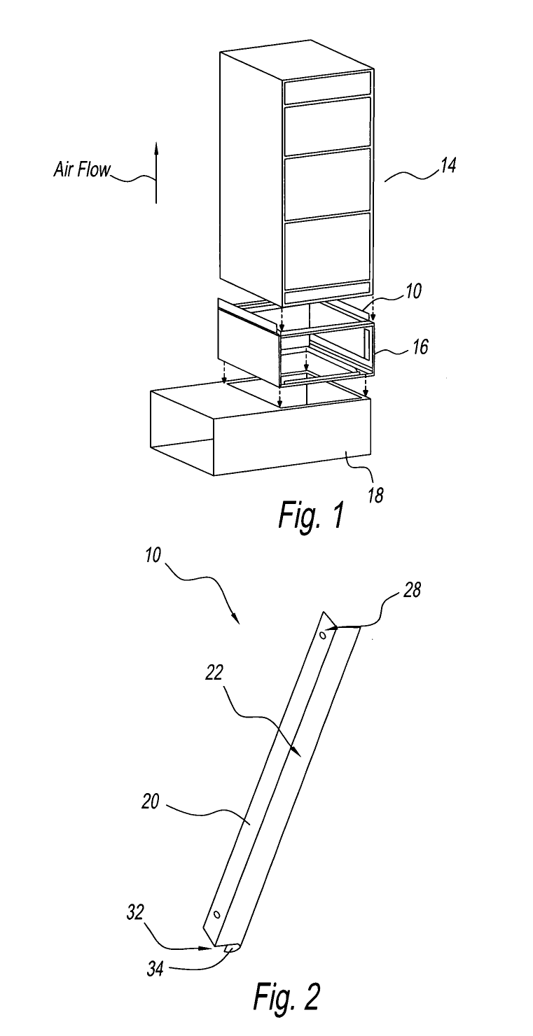

Referring to the drawings and in particular to FIG. 1, an exemplary embodiment of an adapter flange bracket according to the present disclosure is generally illustrated by reference numeral 10. Adapter flange bracket 10 finds use in connecting various components of an HVAC system 12 to one another. For example, HVAC system 12 can include a heat exchanger 14, such as a furnace and/or an air coil, an air cleaner cabinet 16, and a return duct 18. As illustrated, adapter flange bracket 10 finds use in connecting air cleaner cabinet 16 to heat exchanger 14 in an air tight manner so that the air cleaner cabinet is in fluid communication with the heat exchanger. Air cleaner cabinet 16 is configured to support an air cleaning device in the air stream of the HVAC system 12.

FIG. 1 shows HVAC system 12 having an arrangement wherein heat exchanger 14 is above air cabinet cleaner 16, which is above return duct 18. Of course, it is contemplated by the present disclosure for adapter flange brackets 10 to find use with HVAC systems having other configurations where the location and arrangement of heat exchanger 14, air cleaner cabinet 16, and return duct 18 can have any arrangement suitable for making up the HVAC system.

The present disclosure contemplates the use of two adapter flange brackets 10, one on each side of HVAC system 12. For purposes of clarity, only one adapter flange bracket 10 will be described in detail below as the bracket is easily reversible to connect on either side of the HVAC system.

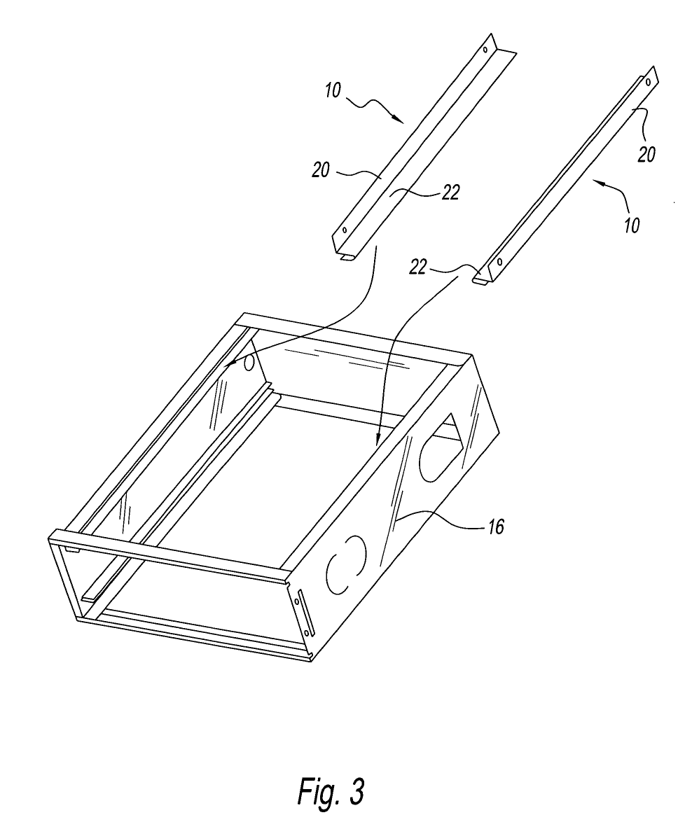

As illustrated in FIGS. 2 through 4, adapter flange bracket 10 is an elongated member having a first side 20 and a second side 22. First and second sides 20 and 22 are arranged so that the first and second sides are associated at an approximately ninety (90) degree angle relative to one another, such that first and second sides 20 and 22 form a generally L-shaped member.

First side 20 includes one or more holes 28 (two shown), where the holes can receive one or more first fastening devices 26 to removably connect first side 20 to heat exchanger 14. In a preferred embodiment, fastener 26 is of any type suitable to removably connect adapter flange bracket 10 to heat exchanger 14. For example, it is contemplated by the present disclosure that fastener 26 may be a screw, a nail, a bolt, and any combinations thereof.

In addition, adapter flange bracket 10 includes at least one second fastening device 32 (only one shown) to removably connect second side 22 to air cleaner cabinet 16. Preferably, second fastening device 32 is a fold over gripping feature that is defined in second side 22 to form a receiving portion 34. In the illustrated embodiment, receiving portion 34 is approximately U-shaped. However, it is contemplated by the present disclosure for second side 22 to be folded such that receiving portion 34 has any desired shape that is suitable to removably connect second side 22 to air cleaner cabinet 16 according to the present disclosure.

Adapter flange bracket 10 can be made of any material having sufficient strength and durability to connect air cleaner cabinet 16 to heat exchanger 14 in a substantially air tight manner so that the return duct is in fluid communication with the heat exchanger. For example, adapter flange bracket 10 can be made of any type of metal (e.g., steel, aluminum, and alloys), or any type of plastic or plastic composition.

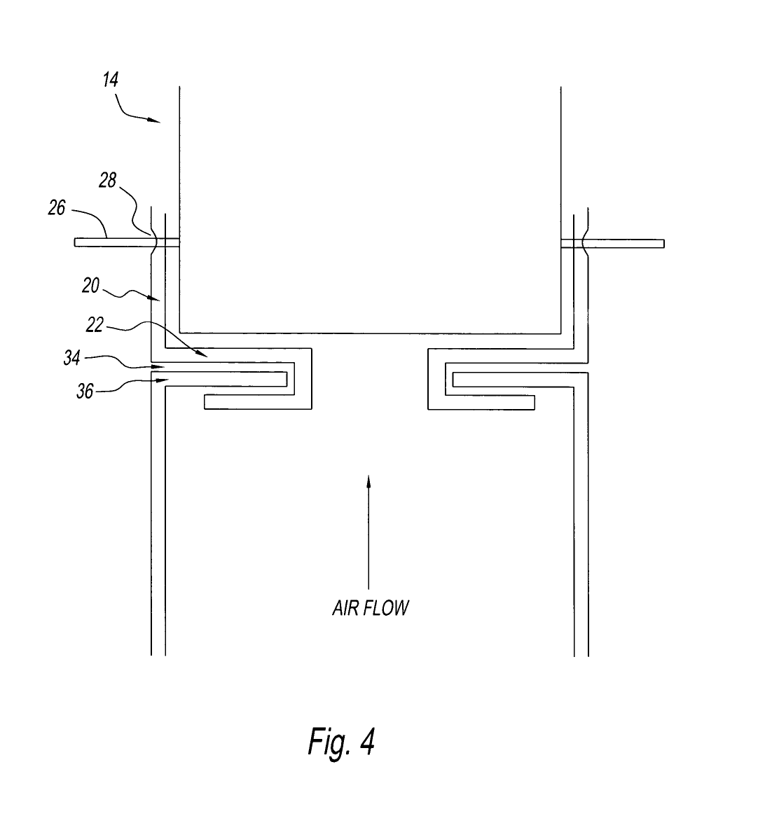

Referring to FIGS. 3 and 4, adapter flange bracket 10 is configured so that receiving portion 34 is received over an ear portion 36 defined on air cleaner cabinet 16. During assembly, receiving portion 34 of one of the adapter flange brackets 10 is positioned over one ear portion 36 of air cleaner cabinet 16 and the receiving portion 34 of a second adapter flange bracket 10 is positioned over another ear portion 36 of the air cleaner cabinet so that the ear portions nest within the receiving portions in a “tongue in cheek” fashion.

In a preferred embodiment, receiving portion 34 is sized so as to form an interference fit with ear potion 36. Next, air cleaner cabinet 16 can be connected to heat exchanger 14 by simply connecting first side 20 to the heat exchanger via fastening devices 26 which pass through holes 28 and into heat exchanger 14. Advantageously, adapter flange bracket 10 forms a substantially airtight connection between air cleaner cabinet 16 and heat exchanger 14.

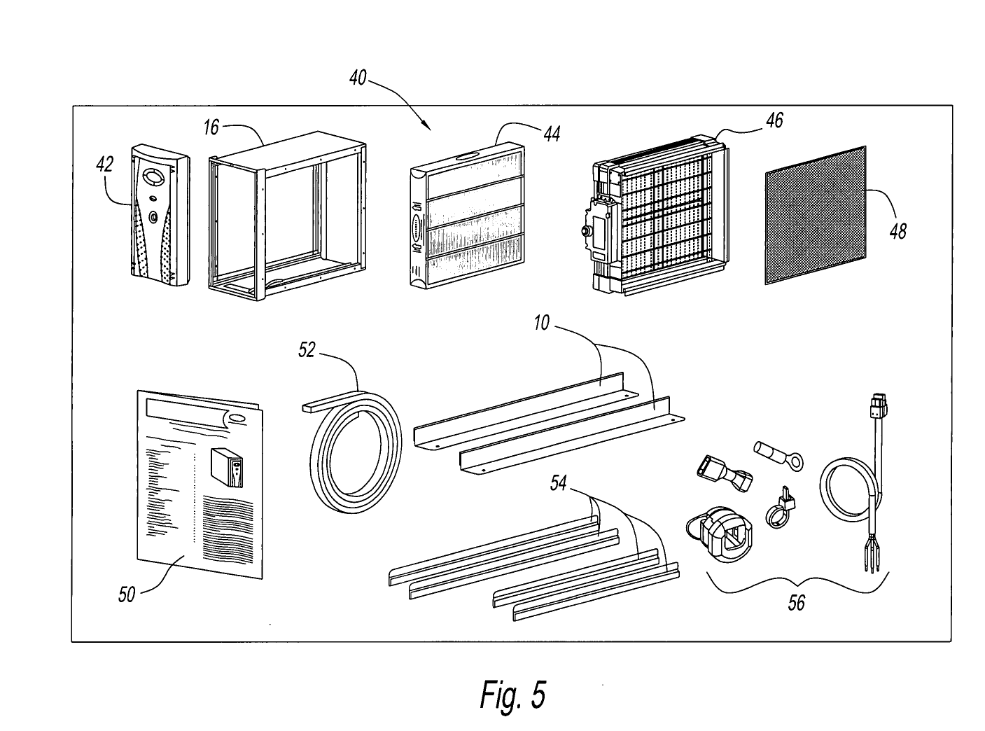

Referring now to FIG. 5, adapter flange bracket 10 according to the present disclosure can be conveniently packaged as a kit 40. Kit 40 can include a pair of adapter flange brackets 10 each having receiving portion 34 and plurality of holes 28 as discussed previously. Additionally, kit 40 can have air cleaner cabinet 16 having ear portions 36, a door 42, an air purification cartridge 44, an enhancement module 46, a safety screen 48, an installation manual 50, a roll of duct gasket tape 52 that can be used to seal any gaps and form airtight connections between heat exchanger 14, a set of return duct adapters 54, a set of installation components 56, and any combinations thereof.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A method of connecting an air cleaner cabinet to a heat exchanger, comprising:
inserting a first ear portion on the air cleaner cabinet into a receiving portion in a first adapter flange bracket so that said first ear portion is removably engaged in said receiving portion of said first adapter flange bracket;
positioning a first side of said first adapter flange bracket in engagement with a second side of the heat exchanger; and
inserting a first set of fasteners through a first set of plurality of holes in said first side of said first adapter flange bracket so that said first side of said first adapter flange bracket is removably connected to said second side.

2. The method of claim 1, wherein said inserting step comprises sliding said first ear portion into said receiving portion.

3. The method of claim 1, wherein said inserting step comprises clipping said receiving portion around said first ear portion so that an interference fit is formed.

4. The method of claim 1, further comprising:
inserting a second ear portion on the air cleaner cabinet into a second receiving portion in a second adapter flange bracket so that that said second ear portion is removably engaged in said second receiving portion of said second adapter flange bracket;
positioning a second side of said second adapter flange bracket in engagement with a third side of the heat exchanger; and
inserting a second set of fasteners through a second set of plurality of holes in said second side of said second adapter flange bracket so that said second side of said second adapter flange bracket is removably connected to said third side.

5. An HVAC system comprising:
a heat exchanger having a plurality of sides;
an air cleaner cabinet having a plurality of sides and a plurality of ear portions;
a plurality of adapter flange brackets, wherein each of said plurality of adapter flange brackets has a first side and a receiving portion, wherein said first side has a plurality of holes, and wherein one of said plurality of ear portions engages with said receiving portion of a respective one of said plurality of adapter flange brackets; and
a set of fasteners, wherein each of said set of fasteners is inserted through each one of said plurality of holes and connects each of said first sides to one of said plurality of sides of said heat exchanger.

6. The HVAC system of claim 5, wherein said set of fasteners is selected from the group consisting of screws, nails, bolts, and any combinations thereof.

7. The HVAC system of claim 5, wherein said receiving portion is approximately U-shaped.

8. The HVAC system of claim 5, wherein each one of said plurality of adapter flange brackets are selected from the group consisting of metal, steel, aluminum, alloys, plastic, plastic composition, and any combination thereof.

9. An air cleaning kit comprising:
a pair of adapter flange brackets, wherein each one of said pair of adapter flange brackets has a receiving portion; and
an air cleaner cabinet having a pair of ear portions, wherein said ear portion can be removably engaged in said receiving portion of a respective one of said pair of adapter flange brackets.

10. The air cleaning kit of claim 9, further comprising a door.

11. The air cleaning kit of claim 9, further comprising an air purification cartridge.

12. The air cleaning kit of claim 9, further comprising an enhancement module.

13. The air cleaning kit of claim 9, further comprising a safety screen.

14. The air cleaning kit of claim 9, further comprising an installation manual.

15. The air cleaning kit of claim 9, further comprising a roll of duct gasket tape.

16. The air cleaning kit of claim 9, further comprising a set of return duct adapters.

17. The air cleaning kit of claim 9, further comprising a set of installation components.
